(19) United States
(12) Patent Application Publication
(10) Pub. No.: US 2005/0163823 A1
(43) Pub. Date: Jul. 28, 2005

(54) Method and composition for reducing ruminant phosphorus excretion

(76) Inventor: Charles Cobb, Hereford, TX (US)

Correspondence Address: HOGAN & HARTSON LLP, ONE TABOR CENTER, SUITE 1500, 1200 SEVENTEENTH ST, DENVER, CO, 80202, US

(21) Appl. No.: 10/767,466

(22) Filed: Jan. 28, 2004

(51) Int. Cl. A23K 1/165

(52) U.S. Cl. 424/442; 424/94.61; 426/53

(57) ABSTRACT

Exogenous enzyme treatment techniques for ruminant feed are provided that are specially adapted for increasing availability of dietary phosphorus and decreasing phosphorus excretion in ruminants. Preferred embodiments of the present invention include compositions comprising an exogenous phytase enzyme and an exogenous cellulase formulation.

### BACKGROUND OF THE INVENTION

1. Field of the Invention

The present invention relates to enzyme treatments for ruminant feed and application techniques relating thereto. More particularly, the present invention relates to compositions comprising exogenous phytase and other exogenous enzymes adapted for treating ruminant feed so as to increase ruminant digestion and retention of dietary phosphorus and reduce phosphorus excretion.

2. Description of the Prior Art

Phosphorous, an essential nutrient for both ruminants and non-ruminants, is necessarily added to the basal feed provided to livestock. Much of this feed material also contains large amounts of phytate. Phytate acts as the primary storage form of phosphorous in most green plant materials and can account for more than 50% of the total phosphorous content of the plant material. Consequently, animal feeds are regularly supplemented with more easily assimilated forms of inorganic phosphorous (e.g., dicalcium phosphate). Roughly 30% of feed phosphorus is captured in meat and milk, and 70% is lost in manure. The excreted phytate, which contains large amounts of phosphorous, increases phosphorous loading to the environment, with concomitant environmental degradation. Accordingly, the increase in intensive, large-scale livestock production has resulted in increased environmental problems, specifically eutrophication of water supplies and other environmental problems related to phosphorous pollution, due to the tremendous amount of manure produced in such enterprises. These problems are expected to increase and may become a major limitation for livestock production in the future. Thus, methods to reduce the level of excreted phytic acid will be a significant benefit for ameliorating these environmental problems.

Currently, feed for non-ruminant animals must be supplemented with inorganic phosphorous because these animal cannot utilize the phosphorous present as phytate. To date the predominant methods that have been contemplated for reduction of phytate in non-ruminant animals have been largely directed to degradation of phytate by the action of phytase enzymes contained within the meal. Several publications describe the use of phytase-containing compositions to increase the bio-availability in mono-gastric animals of the phosphate contained in phytate. Phytases, more properly referred to as myo-inositol hexaphosphate phosphohydrolases, are a family of enzymes which catalyze the step-wise removal of inorganic orthophosphate from phytic acid (myo-inositol 1,2,3,4,5,6-hexakisphosphate). The economic interest in phytase is due to its ability to increase the bio-availability of inorganic phosphorous in phytate-containing non-ruminant animal feeds.

The endogenous phytase activity provided by ruminal microorganisms makes the phosphorus in grains and forages more available to ruminants than to non-ruminants (Clark et al., J. Dairy Sci. 69:3151-3155 (1986); Morse et al., J. Dairy Sci, 75: 1979-1986 (1992); Herbein et al., J. Dairy Sci., 79 (Suppl. 1):229(1996)). However, endogenous enzyme activity in ruminants is not necessarily an accurate predictor of enzyme efficacy when the enzyme is supplied to ruminants from an exogenous source. This is due, in part, to digestion of the exogenous enzymes in the multi-chamber ruminant digestive system, which can result in complete inactivation even if only partial digestion occurs.

Little work has been done to actually test the impact of phytase treatment on availability of dietary phosphorus in ruminants in vivo. While an increase in in vivo phosphorus digestibility observed with treating grains with phytase would imply decreased phosphorus fecal output, however no studies to date have reported decreased phosphorus levels in manure. For example, Hurley et al. (The Professional Animal Scientist, 18:286-292 (2002)) evaluated the effect of feeding microbial phytase on phosphorus availability and feedlot performance of beef steers fed a whole corn-based diets. It was observed that adding phytase at 400-500 FTU/kg levels appears to enhance apparent digestibility of phosphorus, but did not affect finishing calf performance or carcass characteristics compared with lower levels of phytase. Further, the fecal phosphorus percentage was increased.

It can thus be seen that a need remains for a safe and economical technique which reduces phosphorus excretion by livestock. There also remains a need for techniques and compositions which increases the dietary availability of phosphorus in ruminants. It is therefore against the background described above that the advances of the present invention have been made.

### SUMMARY OF THE INVENTION

The present invention relates to enzyme feed treatment techniques which are specially adapted for increasing protein digestibility and retention and decreasing phosphorus excretion of feed by dairy cow, cattle and other ruminants. More specifically, one aspect of this invention provides a composition adapted for application to feed fed ruminants to increase the phosphorus digestibility in the ruminants, comprising an exogenous phytase enzyme and an exogenous cellulase enzyme. Another aspect of this invention comprises a method of increasing phosphorus digestibility of ruminant feed, comprising treating the feed with an exogenous phytase enzyme and other exogenous enzymes, and feeding the treated feed to the ruminants. This invention results in increased retention of phosphorus in the dairy cow milk and/or cattle muscles and decreased phosphorus excretion. In one embodiment of the compositions and methods of this invention, the cellulase enzyme formulation comprises an exogenous pectinase enzyme, an exogenous beta-glucanase enzyme, an exogenous amylase enzyme, an exogenous hemicellulase enzyme and exogenous Trichoderma viride cellulase enzyme.

Additional advantages and novel features of this invention shall be set forth in part in the description that follows, and in part will become apparent to those skilled in the art upon examination of the following specification or may be learned by the practice of the invention. The advantages of the invention may be realized and attained by means of the instrumentalities, combinations, compositions, and methods particularly pointed out in the appended claims.

### DETAILED DESCRIPTION

One aspect of the present invention relates to enzyme compositions used to treat feed which are specially adapted for decreasing phosphorus excretion and increasing phosphorus availability of the feed ingested by dairy cows, cattle and other ruminants such as sheep, goats, bison, deer and the like. More specifically, the enzyme compositions of this invention comprise an exogenous phytase enzyme and an exogenous cellulase enzyme. Feed contacted with the compositions of the present invention demonstrate an increase in phosphorus availability in in vivo tests. An increase in phosphorus availability is evidenced by an increase in apparent phosphorus digestibility as seen, for example, in increased phosphorus milk content, and also in a decrease in phosphorus excretion. This is unexpected because it has been demonstrated (Hurley et al., supra) that treating feed with an exogenous phytase alone does not decrease phosphorus excretion.

Improved phosphorus availability from feed due to the treatment of the feeds with the unique combination of an exogenous phytase enzyme and an exogenous cellulase enzyme according to this invention allows the tissue-level needs of the ruminant to be met with reduced phosphorus intake, thus reducing the phosphorus content of livestock manure. With a greater utilization of phosphorus (i.e., more phosphorus leaving with the milk than in the waste), there is less concern about potential environmental contamination from land application of manure.

Another aspect of this invention provides a method of increasing phosphorus digestibility of feed in ruminants, wherein the method comprises treating the feed with an exogenous phytase enzyme, an exogenous Trichoderma viride cellulase enzyme and optionally one or more of the following other enzymes: an exogenous pectinase enzyme, an exogenous beta-glucanase enzyme, an exogenous amylase enzyme, and/or an exogenous hemicellulase enzyme. The feed treatment steps can be performed (a) sequentially in any order, (b) separately but concurrently, (c) by combining all of the enzymes prior to the treating steps, or (d) by combining two or more of the enzymes prior to the treating steps.

The novel exogenous enzyme compositions and methods of the present invention are useful for treating all kinds of feed, including both harder-to-digest and easier-to-digest grains. As used herein, the term “harder-to-digest” refers to those grains which are utilized less efficiently by animals. Such grains are also said to have a low feeding value and low nutritional value. The harder-to-digest grains include barley, milo (sorghum), rye and oats. Grains which are “easier-to-digest” are those which are utilized more efficiently, have a higher feeding value and higher nutritional value than the hard-to-digest grains. However, the easier-to-digest grains can still benefit from treatments which make more of their nutrients available to animals. The easier-to-digest grains include corn and wheat.

Harder-to-digest grains are utilized less efficiently by animals because of differences in structure and chemical composition of these grains as compared to the easier-to-digest grains. The following factors are important in determining whether a grain should be classified as a hard-to-digest or an easier-to-digest grain:
(1) The amount of beta-glucan contained in the grain. For instance, barley has a very high level of beta-glucan and is a harder-to-digest grain.
(2) The amount of fiber (cellulose and hemicellulose) contained in the grain. For instance, oats has a very high level of cellulose and is a harder-to-digest grain.
(3) The shape and size of the-starch granules. For example, the starch granules in milo (a hard-to-digest grain) are smaller than the starch granules in corn (easier-to-digest grain). Also, the starch granules in milo are spherical and more irregular in shape than the starch granules in corn which are hexagonal and uniform in shape.
(4) The degree of shrouding of the starch granules. For instance, essentially all of the starch granules of milo are shrouded or embedded in the protein matrix or coating of the grain, whereas corn has a substantial percentage of free starch granules.
(5) The density of packing of the starch granules. For example, the starch granules of milo are more tightly packed than those of corn.
(6) The solubility of the protein contained in the grain. For instance, the protein contained in milo and rye is much less soluble than the protein contained in corn.
(7) The degree of complexation of the protein with cellulose and hemicellulose in the grain. The greater the degree of complexation, the harder the grain is to digest.

Bacterial and fungal enzymes are preferred for practicing the invention. To obtain the enzymes, appropriate microorganisms, as described below, are cultured using conventional techniques. Each microorganism is cultured separately, and the enzymes produced during the culture period are blended to produce the enzymatic grain conditioners of the invention. Alternatively, suitable enzymes can be purchased commercially. Crude fermentation products, partially purified fermentation products (e.g., products with microorganisms and non-enzymatically active solids removed) and purified enzymes may be used to prepare the grain conditioners of the invention. The following enzymes are useful in practicing this invention.

1. Phytases

Phytases are a family of enzymes which catalyze the step-wise removal of inorganic orthophosphate from phytic acid (myo-inositol 1,2,3,4,5,6-hexakisphosphate). Exogenous phytases useful in practicing the invention include, but are not limited to, the 6-phytase product Ronozyme P™, marketed by Roche Vitamins Inc. and produced with Peniophoa lycii, Natuphos™, a 3-phytase product marketed by BASF Animal Nutrition, which is produced with Aspergillus niger, and Allzyme™, a 3-phytase product also produced using Aspergillus niger, available from Alltech. Phytases from other sources may be used in the present invention.

2. Pectinases

The pectin carbohydrates which occur in grains are composed of polymers of galacturonic acid (also referred to as pectic acid). Pectin is the methyl ester of pectic acid. The degree of methyl esterification of pectic acid varies with the type of plant, the time of harvest and the growth conditions experienced by the plant.

There are two types of pectinases: depolymerizing pectic enzymes and pectinesterases. Depolymerizing enzymes act either mainly on pectin (polymethylgalacturonase and pectin lyase) or mainly on pectic acid (polygalacturonase and pectate lyase). Each of the types of depolymerizing enzymes may further be either exo- or endo-acting.

In practicing the invention, it is preferable to use a combination of pectinases which can act broadly on the pectic acid, pectin and compounds of similar structure, known generally as “pectic substances,” which are present in the outer coating of grains and are often enmeshed with other grain constituents. Thus, a combination of a pectinesterase and depolymerizing pectic enzymes that act on both pectin and pectic acid is preferred. Further, more preferably, both exo- and endo-acting depolymerizing pectic enzymes are used.

Depolymerizing pectic enzymes suitable for use in the invention are produced by members of the Aspergillus oryzae/soyae and the Aspergillus niger groups of fungi. Also suitable for use in the invention are the depolymerizing pectic enzymes produced by the various species of Rhizopus. In particular, a combination of the depolymerizing pectic enzymes produced by A. niger and R. oryzae are preferred in the practice of the invention.

Pectinesterases and pectate lyases useful in practicing the invention can be obtained by appropriately culturing various species of the genus Bacillus.

3. Beta-Glucanase

Beta-glucan is a linear polymer of glucose that is linked by beta-1,4 and beta-1,3 bonds. Beta-glucan is present in all grains, but the cell walls of barley contain particularly large amounts of beta-glucan.

Beta-glucan is degraded by beta-glucanase (1,3-1,4-beta-D-glucan-4-glucanohydrolase). A combination of the beta-glucanases produced by A. oryzae and B. subtilis is preferred for use in the invention. The beta-glucanase produced by A. oryzae breaks down both beta-1,4 and beta-1,3 bonds, and B. subtilis produces beta-glucanase in larger quantities than other microorganisms.

4. Amylases

Grains, of course, contain considerable amounts of starch, and starch is digested by amylases. Amylases useful in practicing the invention may be obtained by culturing A. oryzae, B. subtilis, B. licheniformis, B. stearothermophilus, Rhizopus oryzae, or other species of Aspergillus. Especially preferred is a combination of the amylases produced by B. subtilis and A. oryzae.

5. Hemicellulase

Hemicellulase degrades the hemicellulose found in grains and plant cell walls. Hemicellulases useful in practicing the invention can be obtained by culturing B. subtilis, A. oryzae and A. niger. Especially preferred is a combination of the hemicellulases produced by B. subtillis and A. oryzae.

6. Cellulase

Generally, enzyme formulations of the present invention include exogenous Trichoderma viride cellulase enzyme, which provides a broad-spectrum fibrolytic enzyme component and has been shown to increase total milk production and protein digestibility of ruminant feed, as further described in U.S. Pat. No. 6,623,750 entitled “Enzyme Composition Adapted for Application to Ruminant Feed to Increase Protein Digestability Thereof and Method of Treating Ruminant Feeds Relating Thereto.” In the enzyme formulations of the present invention, T. viride is used in dry granular form, and all of the microorganisms referred to above as sources of enzymes for use in the invention are well known and widely available.

As stated, the enzyme formulations of the present invention used to treat ruminant feeds include an exogenous phytase enzyme, an exogenous cellulase enzyme, and optionally other exogenous enzymes. One enzyme formulation suitable for application along with an exogenous phytase enzyme to feeds containing easier-to-digest grains (such as corn) to be fed to ruminants (such as cattle) contains dried Aspergilus niger fermentation extract, dried Bacillus subtili fermentation extract, dried Trichoderma viride fermentation extract, dried Aspergillus oryzae fermentation extract and wheat bran, such that alpha-amylase is present in at least 750 units per gram, and total cellulase derived from T. viride and A. niger is present in at least 16,000 units per gram. Preferably, at least 185 grams of the formulation is applied to each ton of feed on a dry matter basis, or 200 grams per metric ton of feed on a dry matter basis. The formulation may presently be obtained by applying an exogenous phytase enzyme to feed and also applying an exogenous enzyme formulation presently available from Loveland Industries, Inc. under the trademark Cattle-Ase™-C Dry Formula.

Another enzyme formulation suitable for application along with an exogenous phytase enzyme to feed containing easier-to-digest grains (such as corn) to be fed to ruminants (such as cattle) contains dried Aspergilus niger fermentation extract, dried Bacillus subtili fermentation extract, dried Trichoderma viride fermentation extract, dried Aspergillus oryzae fermentation extract and propylene glycol, such that alpha-amylase is present in at least 750 units per gram, and total cellulase derived from T. viride and A. niger is present in at least 16,000 units per gram. Preferably, at least 185 grams of the formulation is applied to each ton of feed on a dry matter basis, or 200 grams per metric ton of feed on a dry matter basis. This formulation is presently available form Loveland Industries, Inc. under the trademark Cattle-Ase™-C.

Yet another cellulase enzyme formulation suitable for application along with an exogenous phytase enzyme to feed containing harder-to-digest grains (such as grain sorghum) to be fed to ruminants (such as cattle) contains dried Aspergilus niger fermentation extract, dried Bacillus subtili fermentation extract, dried Trichoderma viride fermentation extract, dried Aspergillus oryzae fermentation extract and propylene glycol, such that beta-glucanase is present in at least 3.2 units per gram, and total cellulase derived from T. viride and A. niger is present in at least 16,000 units per gram. Preferably, at least 185 grams of the formulation is applied to each ton of feed on a dry matter basis, or 200 grams per metric ton of feed on a dry matter basis. This formulation is marketed by Loveland Industries, Inc. under the trademark Cattle-Ase™-B. A related dry formula is available from Loveland Industries, Inc. under the trademark Cattle-Ase™-B Dry Formula. This formulation is adapted for application to feed containing harder-to-digest grains (such as grain sorghum) to be fed to cattle and contains dried Aspergilus niger fermentation extract, dried Bacillus subtili fermentation extract, dried Trichoderma viride fermentation extract, dried Aspergillus oryzae fermentation extract and wheat bran, such that beta-glucanase is present in at least 3.2 units per gram, and total cellulase derived from T. viride and is present in at least 16,000 units per gram. Preferably, at least 185 grams of the formulation is applied to each ton of feed on a dry matter basis, or 200 grams per metric ton of feed on a dry matter basis.

Another cellulase enzyme formulation suitable for application along with an exogenous phytase enzyme to feed containing harder-to-digest grains (such as grain sorghum) to be fed to ruminants (such as cattle) contains dried Aspergilus niger fermentation extract, dried Bacillus subtili fermentation extract, dried Trichoderma viride fermentation extract, dried Aspergillus oryzae fermentation extract and propylene glycol, such that beta-glucanase is present in at least 3.5 units per gram, and total cellulase derived from T. viride and A. niger is present in at least 15,000 units per gram. Preferably, at least 185 grams of the formulation is applied to each ton of feed on a dry matter basis, or 200 grams per metric ton of feed on a dry matter basis. This formulation is marketed by Loveland Industries, Inc. under the trademark Cattle-Ase™-S.

A related dry cellulase enzyme formulation is available from Loveland Industries, Inc. under the trademark Cattle-Ase™-S Dry Formula. This formulation is also adapted for application to feed containing harder-to-digest grains (such as grain sorghum) to be fed to ruminants (such as cattle) and contains dried Aspergilus niger fermentation extract, dried Bacillus subtili fermentation extract, dried Trichoderma viride fermentation extract, dried Aspergillus oryzae fermentation extract and wheat bran, such that beta-glucanase is present in at least 3.5 units per gram, and total cellulase derived from T. viride and A. niger is present in at least 15,000 units per gram. Preferably, at least 185 grams of the formulation is applied to each ton of feed on a dry matter basis, or 200 grams per metric ton of feed on a dry matter basis.

Another cellulase enzyme formulation suitable for application along with an exogenous phytase enzyme to ruminant feed contains dried Trichoderma viride fermentation extract, water and propylene glycol, such that cellulase derived from T. viride is present in at least 15,000 units per gram. Preferably, at least 185 grams of the formulation is applied to each ton of feed on a dry matter basis, or 200 grams per metric ton of feed on a dry matter basis. This formulation is marketed by Loveland Industries, Inc. under the trademark Cattle-Ase™-HR.

Another cellulase enzyme formulation suitable for application along with an exogenous phytase enzyme for application to ruminant feed to increase protein content of milk and/or increase milk production contains dried Trichoderma viride fermentation extract and wheat bran, such that cellulase derived from T. viride is present in at least 15,000 units per gram. Preferably, at least 170 grams of the formulation is applied to each ton of feed on a dry matter basis, or 200 grams per metric ton of feed on a dry matter basis. This formulation is marketed by Loveland Industries, Inc. under the trademark Cattle-Ase™-HR Dry Formula.

The enzyme treatments of the invention may be used to treat feed containing whole grain alone or in combination with any other processing techniques. The enzyme treatments are brought into contact with the feed and incubated with the feed, preferably for at least about 30 minutes. Thirty minutes is typically the minimum time required to transport feed from the processing equipment to the feeders, and generally no additional incubation time is necessary other than the time it takes to transport the processed feed to the feeders. When whole grain is used, a longer incubation (generally about 2-3 hours) is necessary. Of course, a longer incubation can be used even with feed containing processed grain, if desired. Some of the ways in which the enzyme compositions can be used are the following:

1. Mechanical Scarification

In this technique, the enzyme compositions of the present invention are applied in liquid form after the scarification of the grain is complete. An applicator system is used to accurately meter the flow of the enzyme composition onto the flow of feed as it is being moved from the scarifying equipment to the feeders. The enzyme composition should be diluted with the smallest quantity of water that allows for good coverage of the grain. The water may be heated to assist in coverage and penetration of the enzyme composition, but temperatures should not exceed the temperature at which the least thermostable enzyme will be denatured (generally less than about 85° C.). The feed and enzyme composition are preferably incubated together for the time it takes the feed to be transported to the feeders (approximately 30 minutes). Additional incubation time may be used if desired.

2. Grinding and Rolling

Grains may be ground by passing them through a hammermill or rolled by passing it between two rollers while the grain is dry or after treatment with a conventional grain conditioner (containing a surfactant, acid or base) and water prior to rolling to increase the moisture level of the grain (preconditioned rolled grain).

Also, the grain can be subjected to steam before being rolled. For instance, grain can be treated in a steam chamber at about 65°-85° C. for about 5-10 minutes before rolling (steam rolled grain) or can be treated in a steam chamber at about 90°-105° C. for about 20-30 minutes before being rolled into flakes (steam flaked grain). Grains are often treated with conventional grain conditioners prior to steam rolling and steam flaking to assist in moisture and heat penetration.

Feed containing rolled or ground grain is treated with the enzyme compositions of the present invention after grinding or rolling. The liquid enzyme compositions or a dry enzyme composition dissolved in water may be applied and incubated with the feed as described above for mechanically scarified grain. The temperature of the feed when the enzyme composition is applied should not exceed about 85° C. Ground grains treated with the enzyme compositions of the invention may also subsequently be pelleted to form an animal feed.

3. Soaking

Grain, whole or processed, and feeds generally, may be soaked in water to increase the moisture level, preferably to 20% or greater and most preferably to 28-30%. For instance, whole grain or scarified grain can be soaked in water for a period of 12-24 hours. While soaking, the grains can be treated with the enzyme compositions of the invention by adding the composition (dry or wet) to the water in which the grain/feed is soaked. Soaked whole grains/feed can be fed immediately to animals, can be processed after soaking (generally by rolling) or can be stored in airtight containers for periods up to 21 days before being fed. Also, whole grain can be soaked in water, processed (such as by rolling), treated with the enzyme compositions of the invention and then fed.

4. Popped or Exploded

Grains can be exposed to radiant heat or super-heated air for very short times (10-20 seconds) which causes the grain to pop or explode. A liquid enzyme composition is then applied to and incubated with the popped or exploded grain as described above for mechanical scarification.

5. Chemical Scarification

Grains can be chemically scarified with a conventional acid-type or base-type grain conditioner in the conventional manner. An enzyme composition of the invention is then applied to and incubated with the chemically-scarified grain as described above for mechanical scarification.

6. High Moisture Grains

High moisture grains are grains harvested at higher than normal moisture levels. These grains are ground or rolled and then treated with the enzyme compositions of the invention as described above for mechanical scarification. Finally, feed containing the grain is stored in pits or silos until needed.

### EXAMPLE

### Effect Of Dietary Phosphorus and Exogenous Phytase on Lactating Cows

Unexpected increases in phosphorus digestibility and decreases in phosphorus excretion have been observed upon treating feed with an exogenous phytase and a Cattle-Ase™ enzyme formulation and feeding lactating Holstein dairy cattle with the treated grain.

Ingredient and nutrient composition of treatment diets are shown in Tables 1 and 2, respectively. Diets contained about 17% protein and 26% NDF (neutral detergent fiber) and differed only in phosphorous content.

TABLE 1

| | High P | Low P | Low P-phytase |
|---|---|---|---|
| Ingredient | % of diet Dry matter | | |
| Corn silage | 45.3 | 45.0 | 45.0 |
| Corn grain, ground | 32.8 | 32.7 | 32.7 |
| Soybean meal, 48% CP | 14.7 | 14.7 | 14.7 |
| Expeller soybean meal¹ | 1.37 | 1.36 | 1.36 |
| Sodium bicarbonate | 0.53 | 0.52 | 0.52 |
| Urea | 0.53 | 0.52 | 0.52 |
| Calcium carbonate | 1.41 | 1.89 | 1.88 |
| Salt | 0.19 | 0.19 | 0.19 |
| Phytase enzyme formulation | 0.00 | 0.00 | 0.04 |
| Vitamin-Mineral Mix² | 3.16 | 3.14 | 3.14 |

¹Soyplus ™, West Central Soy, Ralston, IA
²Each kg contained 300 mg MG, 150 mg S, 10 mg Co, 400 mg Cu, 20 mg I, 500 mg Mn, 7.75 mg Se, 1000 mg Zn, 150,000 IU Vitamin A, 50,000 IU Vitamin D, and 750 IU Vitamin E.

TABLE 2

| Nu- | | | Low P- | | P< | | |
|---|---|---|---|---|---|---|---|
| trient | High P | Low P | phytase | SEm | Trt | Dietary P | Phytase |
| CP | 17.4 | 17.1 | 17.4 | 0.35 | 0.75 | 0.69 | 0.53 |
| ADF | 14.1 | 14.2 | 14.1 | 0.06 | 0.55 | 0.41 | 0.49 |
| NDF | 26.1 | 26.1 | 26.0 | 0.16 | 0.83 | 0.73 | 0.62 |
| P | 0.47 | 0.32 | 0.32 | 0.01 | 0.01 | 0.01 | 0.87 |

Nine early lactation cows (six ruminally-cannulated) were fed diets containing low (“low P”) or high (“high P”) phosphorus levels (about 70% and 120%, respectively, of required, according to NRC 2001). The low phosphorus diets were fed with or without the addition of Cattle-Ase C plus phytase enzyme formulation.

Cows were grouped by calving date and previous lactation mature equivalent milk yield, and assigned to one of three, 3×3 Latin squares. Squares were balances for carryover effects. Each experimental period lasted 21 days. Cows were fed in Calan doors for the first 17 days of each period, and were moved to individual stalls on day 18 for total collection of feces, urine and milk. Cows were fed once daily at 0800 h and milked at 0700 h and 1900 h. Feed was offered 5-10% in excess of the previous day's intake (wet basis).

On day 18, a sterile Foley urine catheter (22 French, 75 cc; C. R. Bard, Inc., Covington, Ga.) was inserted into the urethra for total collection of urine. All excreted urine, feces and milk were collected on days 19, 20 and 21. Urine was weighed at 4-hour intervals, acidified (22 mL of 6N HCl/kg urine), pooled, subsampled after 24 hours, and stored frozen for later analysis. All excreted feces were collected at 4-hours intervals and stored in a sealed container, then weighed, thoroughly mixed, and subsampled daily. Feed ingredients (foraged and concentrates) were sampled once each week, and feed refusals were weighed and sampled daily. On days 19, 20 and 21, feed offered and refused were measured, total milk weights were recorded, and milk was sampled at six consecutive milkings.

Samples of feed refusals, feed ingredients, feces, and ruminal contents were dried to constant weight at 60° C. in a forced air drying oven (Wisconsin Oven, Memmert; Schwabach, Germany). Dried samples were ground through a 1-mm screen in a Wiley Mill (Aurther H. Tomass, Philadelphia, Pa.). Feed and feed refusal samples were analyzed in duplicate for N, P (AOAC, 1984), and NDF and AF sequentially with alpha-amylase (Van Soest, et al., J. Dairy Sci., 74:3583-3597 (1991)). Feces samples were analyzed for phosphorus and NDF as descried, and urine samples were analyzed for phosphorus (AOAC, 1984). Milk samples were analyzed for fat, protein, total solids, SNF (Dairy Herd Improvement Association, Blacksburg, Va.) and phosphorus (AOAC, 1984). Retention, milk output, and excretion of phosphorus were calculated Rumen fluid samples were analyzed for phytase activity (Yanke, et al., Microbiology, 144:1565-1573 (1998).

All data were analyzed using the MIXED procedure of SAS (SAS Institute, 1999) using Equation 1:
Yᵢⱼₖₗ=μ+Sᵢ+Cⱼ(S)ᵢ+Dₖ+Tₗ+eᵢⱼₖₗ (1)
where μ=overall mean, Sᵢ=random effect of square (i=1 to 3), Cⱼ(S)ᵢ=random effect of cow within square (j=1 to 3), Dₖ=fixed effect of period (k=1-4), Tₗ=fixed effect of treatment (l=1 to 3), and eᵢⱼₖₗ=residual error.

Residual error was used to test the main effect of treatment and pre-planned contrasts were used to evaluate the effect of dietary phosphorus (high P vs. low P and low P-phytase) and phytase addition (low P vs. low P-phytase). Differences were declared significant at P<0.05 and trends at P<0.15. The results are reported as least squares means.

As shown in Table 3, neither dietary phosphorus content nor exogenous phytase affected milk yield (39.6 kg/d) or milk composition (Table 3). Milk fat content was low (3% or less), reflecting the relatively low forage content (45%) and the use of corn silage as the sole source of forage.

TABLE 3

| | | | | | P< | | |
|---|---|---|---|---|---|---|---|
| | High | Low | Low P- | | | Dietary | |
| | P | P | phytase | SEm | Trt | P | Phytase |
| Milk yield kg/d | 38.70 | 38.83 | 41.30 | 2.34 | 0.45 | 0.51 | 0.30 |
| Milk fat % | 2.82 | 2.92 | 3.02 | 0.20 | 0.59 | 0.41 | 0.59 |
| Milk true | 2.82 | 2.80 | 2.77 | 0.00 | 0.80 | 0.58 | 0.73 |
| protein % | | | | | | | |
| Milk lactose % | 4.71 | 4.70 | 4.77 | 0.08 | 0.34 | 0.61 | 0.18 |
| Milk SNF % | 8.49 | 8.42 | 8.50 | 0.11 | 0.62 | 0.70 | 0.37 |
| MUN mg/dl | 16.6 | 15.3 | 16.2 | 1.2 | 0.51 | 0.38 | 0.43 |
| Milk fat kg/d | 0.55 | 0.58 | 0.63 | 0.05 | 0.25 | 0.19 | 0.33 |
| Milk true | 0.55 | 0.54 | 0.55 | 0.95 | 0.85 | 0.95 | 0.57 |
| protein kg/d | | | | | | | |
| Milk lactose | 0.92 | 0.92 | 0.96 | 0.07 | 0.80 | 0.76 | 0.57 |
| kg/d | | | | | | | |
| Milk SNF kg/d | 1.65 | 1.64 | 1.71 | 0.12 | 0.84 | 0.86 | 0.59 |

As shown by the data in Table 4, dry matter intake (21.8 kg/d) and excretion of feces (5.85 kg/d DM and 37.9 kg/d wet) were unaffected by diet, but urine excretion was lower by cows fed low phosphorus diets than cows fed high phosphorus diets (16.5 vs. 21.3 kg/d; P<0.01). Only one other experiment has reported an effect of dietary phosphorus content on urine excretion. Burkholder et al. (J. Dairy Sci. (Suppl. 1), 85:320 (2002)) observed that cows fed supplemental purified phytic acid excreted more urine (+1.9 kg/d) than cows fed low phosphorus diets. In the absence of water consumption, no biological explanation for this observation is apparent.

TABLE 4

| | | | | | P< | | |
|---|---|---|---|---|---|---|---|
| | High | Low | Low P- | | | Dietary | |
| | P | P | phytase | SEm | Trt | P | Phytase |
| DMI, kg/d | 22.2 | 21.5 | 21.7 | 1.35 | 0.89 | 0.65 | 0.87 |
| Apparent DM digestibility % | 72.65 | 72.05 | 73.21 | 1.52 | 0.78 | 0.99 | 0.49 |
| Fecal excretion, kg/d DM | 5.78 | 5.98 | 5.80 | 0.53 | 0.91 | 0.82 | 0.71 |
| Fecal excretion, kg/d wet | 37.80 | 38.80 | 37.10 | 3.61 | 0.85 | 0.97 | 0.57 |
| Urine output, kg/d | 21.30 | 15.50 | 17.50 | 1.43 | 0.01 | 0.01 | 0.13 |

Compared to cows fed high phosphorus diets, cows fed low phosphorus diets had reduced phosphorus intake (68.1 vs. 103.9 g/d), reduced fecal phosphorus excretion (35.8 vs. 51.3), reduced urinary phosphorus excretion (1.5 vs. 5.4 g/d), and lower phosphorus balance (−6.7 vs. 8.3 g/d) as shown in Table 5.

TABLE 5

| | | | | | P< | | |
|---|---|---|---|---|---|---|---|
| | | Low | Low P- | | | Dietary | |
| | High P | P | phytase | SEm | Trt | P | Phytase |
| P intake, g/d | 103.93 | 66.69 | 69.49 | 5.36 | 0.01 | 0.01 | 0.66 |
| Fecal P excretion, g/d | 51.34 | 37.97 | 33.59 | 4.46 | 0.02 | 0.01 | 0.41 |
| Apparent P digestibility, % | 46.56 | 40.50 | 50.10 | 4.47 | 0.25 | 0.80 | 0.11 |
| Urinary P, g/d | 5.42 | 1.87 | 1.20 | 1.47 | 0.03 | 0.01 | 0.65 |
| Total P excretion, g/d | 56.5 | 40.0 | 34.8 | 3.81 | 0.01 | 0.01 | 0.32 |
| Ruminal phytase activity, | 24.0 | 22.2 | 18.8 | 4.65 | 0.69 | 0.89 | 0.41 |
| nmol Pi released/min/MI | | | | | | | |
| Milk P, g/d | 34.34 | 33.15 | 35.39 | 2.20 | 0.58 | 0.97 | 0.31 |
| Milk P, of P intake | 34.9 | 51.7 | 51.3 | 3.2 | 0.01 | 0.01 | 0.91 |
| P balance, g/d | 8.28 | −8.82 | −4.58 | 3.33 | 0.01 | 0.01 | 33 |

Apparent phosphorus digestibility was unaffected by dietary phosphorus content, similar to the observations of Guyton et al. (J. Dairy Sci., (Suppl. 1) 85:44 (2002)). Milk phosphorus secretion as a percent of phosphorus intake was higher in cows fed the low phosphorus diets than in cows fed high phosphorus diets (51.5 vs. 34.9%; P<0.01).

Addition of exogenous phytase did not affect phosphorus intake, milk phosphorus, fecal phosphorus, or urinary phosphorus excretion (Table 5), but apparent phosphorus digestibility tended to be higher in cows supplemented with phytase (50.1 vs. 40.5% for low P-phytase and low P, respectively; P<0.11). Table 5 further demonstrates that endogenous ruminal phytase activity was not affected by treatment, or by either main effect (dietary phosphorus content and exogenous phytase supplementation).

The increased apparent phosphorus digestibility observed with supplementation with exogenous phytase was due to a slight numerical increase in phosphorus intake (+2.8 g/d) combined with a numerical decrease in fecal phosphorus excretion (−5.4 g/cow/d). Thus, while most published studies have reported that ruminal phytase activity does not limit digestion of dietary phosphorus, the present invention indicates that there is opportunity to increase the availability of dietary phosphorus with exogenous phytase. Indeed, with roughly 750,000 dairy cows in the Chesapeake Bay Watershed (Jonker and Kohn, J. Dairy Sci., 76: (Suppl. 1):348 (1998)), an increase in phosphorus availability of this magnitude and the appropriate reduction in phosphorus intake would reduce phosphorus excretion by 1750 metric tons per year, or the equivalent of 3500 metric tons of P₂O₅ per year.

The lack of effect of exogenous phytase on endogenous phytase activity suggests that at these levels of supplementation, there is no inhibition of the natural phytase activity of the ruminal microorganisms. The lack of effect of dietary phosphorus (i.e., the addition of supplemental inorganic phosphorus) means the addition of exogenous phytase will be equally effective in high and low phosphorus diets, such as when the addition phosphorus is of inorganic origin. The biological interpretation of this is that there is no negative feedback of concentration of inorganic phosphorus in the ruminal fluid on the natural phytase activity of ruminal microorganisms. This kind of information is critical to the ultimate implementation of exogenous phytase in ruminant diets.

This example demonstrates for the first time the improved availability of dietary phosphorus in ruminants with the addition of exogenous phytase. Further, this example demonstrates that exogenous phytase is equally effective in improving apparent phosphorus digestibility in high and low phosphorus diets, and supplementation with exogenous phytase has no negative impact on endogenous phytase activity.

The foregoing description is considered as illustrative only of the principles of the invention. Further, since numerous modifications and changes will be readily apparent to those skilled in the art, it is not desired to limit the invention to the exact construction and process shown as described above. Accordingly, all suitable modifications and equivalents may be resorted to falling within the scope of the invention as defined by the claims that follow.

The words “comprise,” “comprising,” “include,” “including,” and “includes” when used in this specification and in the following claims are intended to specify the presence of stated features, integers, components, or steps, but they do not preclude the presence or addition of one or more other features, integers, components, steps, or groups thereof.

1. A composition adapted for application to ruminant feed to increase the phosphorus digestibility of the feed by the ruminants, comprising an exogenous phytase enzyme and an exogenous cellulase enzyme.

2. The composition of claim 1, wherein the exogenous cellulase enzyme comprises a Trichoderma viride cellulase enzyme.

3. The composition of claim 1, wherein said composition further comprises exogenous pectinase, beta-glucanase, amylase and hemicellulase enzymes.

4. The composition of claim 3 wherein the sources of the exogenous enzymes include one or more fermentation extracts selected from the group consisting of a Trichoderma viride fermentation extract, an Aspergillus niger fermentation extract, a Bacillus subtili fermentation extract, and an Aspergillus oryzae fermentation extract.

5. A method of increasing phosphorus digestibility of ruminant feed comprising the steps of:
treating the feed with an exogenous phytase enzyme and with an exogenous enzyme formulation; and
feeding the treated feed to ruminants.

6. The method of claim 5 further comprising the step of:
treating the feed with one or more exogenous enzyme selected from the group consisting of an exogenous pectinase enzyme, an exogenous beta-glucanase enzyme, an exogenous amylase enzyme and an exogenous hemicellulase enzyme.

7. The method of claim 6, wherein the feed treatment steps are performed (a) sequentially in any order, (b) separately but concurrently, (c) by combining all of said enzymes prior to the treating steps, or (d) by combining two or more of said enzymes prior to the treating steps.

8. The method of claim 6 wherein the feed includes corn.

9. The method of claim 6 wherein the ruminants comprise dairy cows.

10. The method of claim 6 wherein the ruminants comprise beef cattle.
